(19) United States
(12) Patent Application Publication
(10) Pub. No.: US 2015/0133406 A1
(43) Pub. Date: May 14, 2015

(54) SYNERGISTIC FORMULATIONS FOR CONTROL AND REPELLENCY OF BITING ARTHROPODS

(71) Applicant: Bedoukian Research, Inc., Danbury, CT (US)

(72) Inventor: Robert H. BEDOUKIAN, West Redding, CT (US)

(21) Appl. No.: 14/540,612

(22) Filed: Nov. 13, 2014

Related U.S. Application Data
(60) Provisional application No. 61/962,663, filed on Nov. 13, 2013.

(51) Int. Cl. A01N 37/18; A01N 37/40; A01N 35/02; A01N 37/36; A01N 43/08; A01N 31/06

(52) U.S. Cl. CPC A01N 37/18; A01N 43/08; A01N 31/06; A01N 35/02; A01N 37/36; A01N 37/40
USPC 514/159; 514/617; 514/473; 514/557; 514/675

(57) ABSTRACT

Control or repellency of biting arthropods, particularly biting insects, is accomplished by bringing the biting arthropods into contact with combinations of compounds identical or related to those found on human/animal skin or in plants acting synergistically with one another, or in combination with conventional repellents like DEET®, para-menthane-3,8-diol (PMD), sec-butyl-2-(2-hydroxyethyl) piperidine carboxylate (“Picaridin”), or other nitrogen containing repellents selected from amines, amides and nitrogen containing heterocyclic compounds, or any synergistic combination of DEET®, PMD, Picaridin, or other nitrogen containing repellents selected from amines, amides and nitrogen containing heterocyclic compounds.

### RELATED APPLICATION

This application claims the benefit of copending U.S. Application No. 61/962,663, filed Nov. 13, 2013, which is incorporated herein by reference in its entirety.

### FIELD OF THE DISCLOSURE

This disclosure relates to repellent formulations of compounds used synergistically as agents to control and repel biting arthropods, and especially biting insects.

### BACKGROUND TO THE DISCLOSURE

Many mammals, including humans, have suffered the action of mosquitoes and other biting insects. The blood sucking of mosquitoes results in an itching sensation and often a rash. Also, many mosquitoes cause potentially life-threatening illness. Aedes aegypti can cause dengue fever and yellow fever, Anopheles quadrimaculatus can cause malaria and Culex quinquefasciatus can cause West Nile disease. One possible solution to these problems is applying an insect repelling agent to the skin as a topical repellent. Applying arthropod or insect repellents to fabric, like mosquito netting, is another way of reducing arthropod, insect or mosquito bites.

DEET®, namely N,N-Diethyl-m-toluamide, is widely used against biting arthropods and insects, but is characterized by an unseemly bad smell, is not particularly long lasting in its effect and it dissolves plastics. Moreover, several safety questions have been raised concerning the use of DEBT® and some governments have restricted the amount of the active component that may be employed in formulations. This itself presents a further problem since the efficacy of DEET® declines over time and therefore it needs to be formulated at higher than effective dosages in order to maintain its effectiveness. Furthermore, some insects and pests have developed resistance to DEBT® due to its wide spread usage. Other repellents, such as para-menthane-3,8-diol (PMD), are relatively expensive.

As such, there is a need to provide a biting insect repellent formulation that can reduce or eliminate the use of standard repellents like DEBT®, PMD or sec-butyl-2-(2-hydroxyethyl) piperidine carboxylate (“Picaridin”).

Testing has shown that many novel biting arthropod or insect repellents developed at Bedoukian Research, Inc. (“BRI”) perform much better than conventional repellents like DEET®, PMD, and Picaridin when tested in vitro using warm blood as the attractant on Aedes aegypti. However, conventional repellents consistently outperform the BRI materials when tested on humans. Most interesting is that while the BRI repellents perform similarly or have less repellency on humans compared with their laboratory performance, most conventional repellents (for example DEET and PMD) perform far better on human skin than in the lab.

While searching for the mechanism for these phenomena, we have found that there is a synergistic effect with compounds found on human/animal skin and compounds structurally similar to those compounds, or those compounds and related materials found in plants and these conventional repellents DEET®, PMD, Picaridin, or other nitrogen containing repellent compounds. Additionally, we will show synergy of conventional repellents with one another.

### SUMMARY OF THE DISCLOSURE

In accordance with this disclosure, control and repellency of biting arthropods, and particularly biting insects, is obtained by contact of the biting arthropods with novel biting arthropod repellent formulations based on skin or plant derived compounds and compounds structurally similar to them, acting synergistically with one another or with conventional repellents such as DEET®, PMD, Picaridin, or other nitrogen containing repellent compounds such as amides, amines and nitrogen containing heterocyclic compounds, or such conventional repellents in synergistic combinations with one another.

### BRIEF DESCRIPTION OF THE DRAWINGS

FIG. 1 shows the results of laboratory testing for additive repellency of certain combinations of compounds in accordance with this disclosure.

FIG. 2 shows the results of human testing for dose response curves of certain individual compounds in accordance with this disclosure.

FIG. 3 shows the results of human testing for dose response curves of certain combinations of compounds in accordance with this disclosure.

FIG. 4 shows the results of ED50 comparisons of certain combinations of compounds, based on the dose of DEET or PMD, in accordance with this disclosure.

FIG. 5 shows the results of additive comparisons of certain combinations of compounds, based on the dose of DEET or PMD, in accordance with this disclosure.

### DETAILED DESCRIPTION OF THE DISCLOSURE

Control and repellency of biting arthropods, and especially biting insects, is obtained by contact of the biting arthropods with novel biting arthropod repellent formulations based on biting arthropod repellents found on human/animal skin or in plants taken from the certain chemical families (such as, for example ketones, cyclic ketones, esters, gamma or delta lactones and branched and/or unsaturated carboxylic acids similar to those found on human/animal skin or in plants) acting synergistically with one another, or acting synergistically with conventional repellents like DEET®, PMD, Picaridin, or nitrogen containing repellent compounds such as amides, amines and nitrogen containing heterocyclic compounds, such as pyrazines. The disclosure also consists of synergistic combinations of such conventional repellents with one another.

The synergistic biting arthropod and especially biting insect, repellent formulation of this disclosure may comprise synergistic formulations of:

(I) any synergistic combination of compounds (a), wherein compounds (a) are selected from the group comprising or consisting of:

(1) alkyl ketones, saturated or unsaturated, branched or unbranched, containing from about 6 to about 18, preferably about 10 to about 18 carbon atoms, or any range of carbon atoms within said range, including geranyl acetone, farnesyl acetone, 6-methyl-5-hepten-2-one, 2-undecanone, and 2-tridecanone;

(2) compounds of the structure (A)

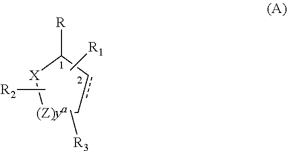

wherein
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated hydrocarbyl group with zero to two double bonds and from about 1 to about 15 carbon atoms or any range of carbon atoms with said range;
R₂ is selected from H and a branched or straight chain, saturated or unsaturated hydrocarbyl group with zero to three double bonds and from about 1 to about 15 carbon atoms or any range of carbon atoms with said range;
R₃ is selected from H, a branched or straight chain, saturated or unsaturated hydrocarbyl group with zero to three double bonds and from about 1 to about 15 carbon atoms or any range of carbon atoms with said range, —(CH₂)ₙOH, —C(O)OR₅, —CH₂C(O)OR₇, —CH₂C(O)R₈, —C(O)NR₉R₁₀, and —CH₂C(O)NR₁₁R₁₂ where each of R₅, R₇, R₈, R₉, R₁₀, R₁₁ and R₁₂ is independently selected from H and a branched or straight chain, saturated or unsaturated hydrocarbyl group with zero to three double bonds and from about 1 to about 15 carbon atoms or any range of carbon atoms with said range, and n is n integer of from 1 to 12 or any range of integers within said range;
the bond between the 2 and 3 positions in the ring structure may be a single or a double bond; and
wherein the compounds of structure (A) contain from about 11 to about 20 carbon atoms or any range of carbon atoms with said range, except where R is ═O, X═CH₂ and y is 1 the compounds of structure (A) contain from about 13 to about 20 carbon atoms or any range of carbon atoms with said range, and includes optical isomers, diastereomers and enantiomers of the compounds of structure (A); and

(3) branched or unbranched, straight chain or cyclic, saturated or unsaturated, carboxylic acids containing from about 3 to about 18 carbon atoms or any range of carbon atoms within said range, specifically including lactic acid, salicylic acid, and geranic acid, 3-methyl-2-decenoic acid, and including any and all isomers thereof; and

(4) esters of branched or unbranched, straight chain or cyclic, saturated or unsaturated, carboxylic acids containing a total of from about 3 to about 18 carbon atoms or any range of carbon atoms within said range including esters of salicylic acid, specifically including methyl salicylate, amyl and isoamyl salicylate, hexyl salicylate and cis-3-hexenyl salicylate;

(II) one or more of the compounds (a) in combination with one or more of the repellents DEET®, PMD, Picaridin, or other nitrogen containing repellents selected from amines, amides and nitrogen containing heterocyclic compounds; and/or
(III) any synergistic combination of the repellents DEET®, PMD, Picaridin, or other nitrogen containing repellents selected from amines, amides and nitrogen containing heterocyclic compounds.

The disclosure also comprises control of such biting arthropods, especially biting insects, by bringing the biting arthropods into contact with one of said synergistic arthropod repellent formulations.

As examples of alkyl ketones of compounds (a) there may be mentioned geranyl acetone (6,10-dimethyl-5,9-undecadien-2-one), farnesyl acetone (5,9,13-pentadecatrien-2-one, 6,10,14-trimethyl-) methyl undecyl ketone (2-tridecanone), methyl decyl ketone (2-dodecanone), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), isobutylionone ((E)-5-methyl-1-(2,6,6-trimethyl-1-cyclohex-2-enyl)hex-1-en-3-one), isolongifolen-9-one ((1R)-2,2,7,7-tetramethyltricyclo[6.2.1.01,6]undec-5-en-4-one), dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone (2-undecanone), and 3-decen-2-one. Especially preferred are methyl decyl ketone, methyl undecyl ketone, methyl nonyl ketone, geranyl acetone, farnesyl acetone, ionone, and isolongifolenone.

Representative examples of alkyl ketones of compounds (a) include, but are not limited to, geranyl acetone having the formula

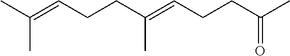

and a methyl ketone with variable chain length (e.g., R is a hydrocarbon group having from about 1 to about 18 carbon atoms)

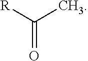

Representative preferred examples of alkyl ketones of compounds (a) include, but are not limited to, geranyl acetone, farnesyl acetone, methyl undecyl ketone, and methyl nonyl ketone.

Representative examples of compounds of structure (A) of compounds (a) include, but are not limited to,

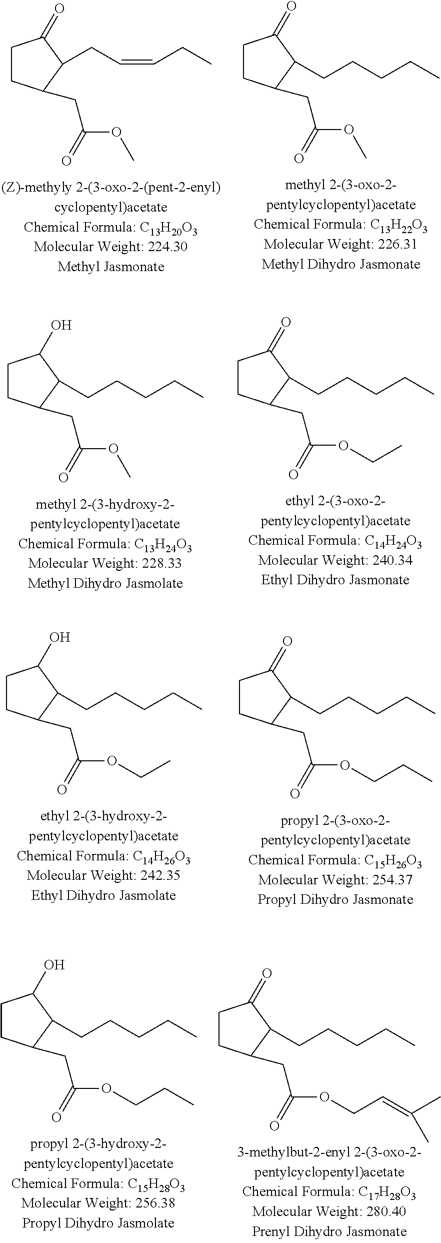

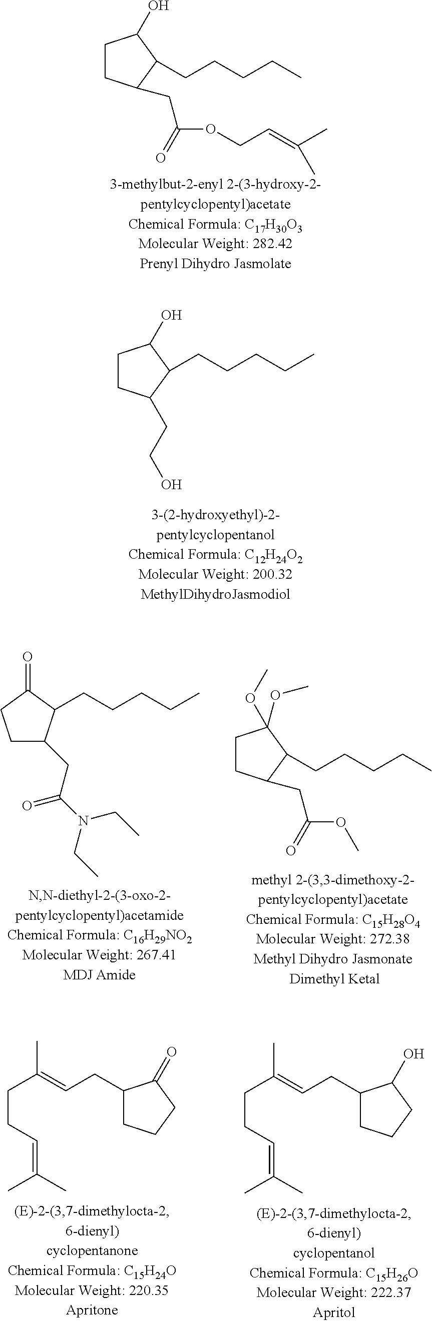 [SMILES: CCCCCC1C(O)CCC1CC(=O)OCC=C(C)C ; CCCCCC1C(O)CCC1CCO ; CCCCCC1C(=O)CCC1CC(=O)N(CC)CC ; CCCCCC1C(CC(=O)OC)CCC1(OC)OC ; CC(C)=CCC/C(C)=C/CC1CCCC1=O ; CC(C)=CCC/C(C)=C/CC1CCCC1O]

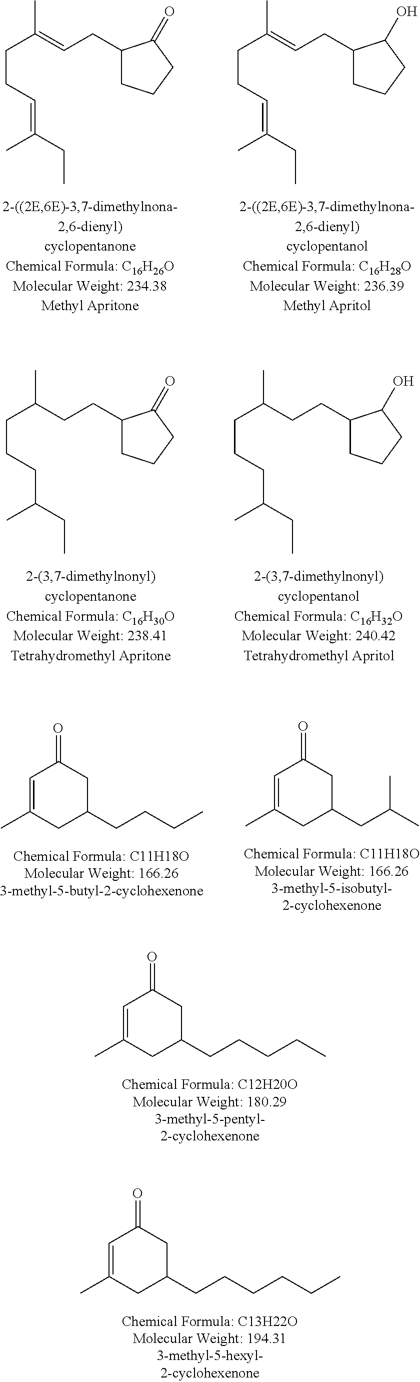

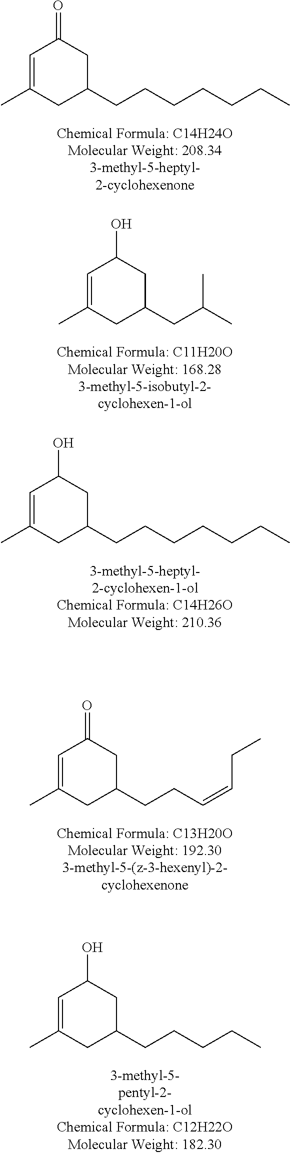

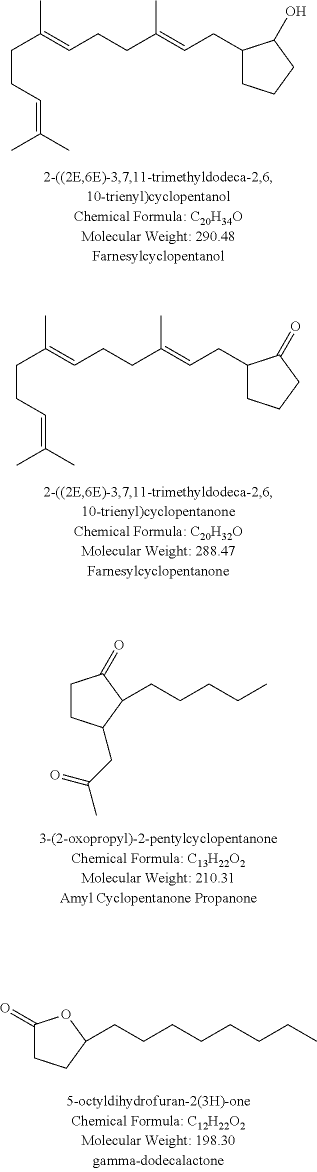 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O ; CCCCCCCCC1CCC(=O)O1]

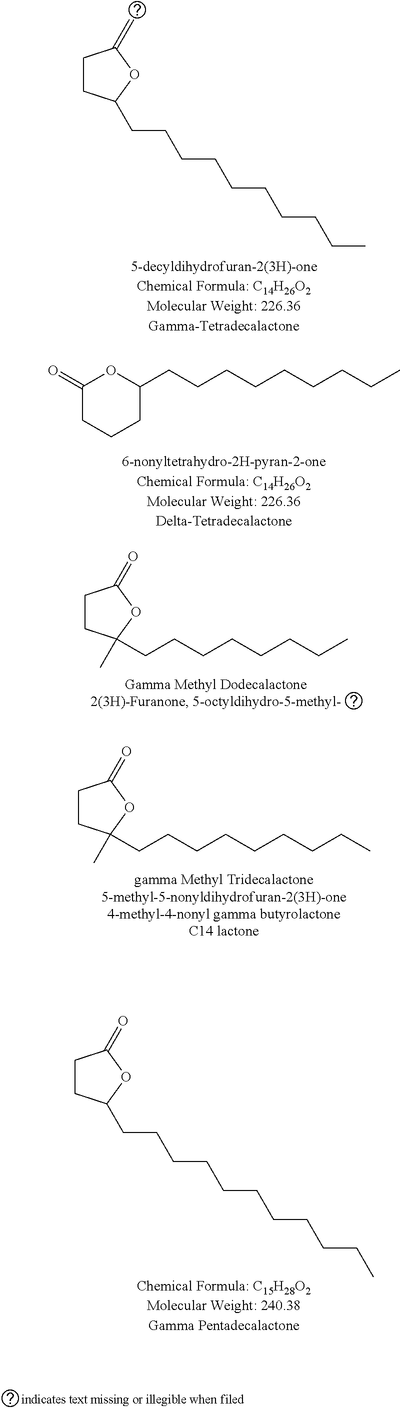 [SMILES: C=C1CCC(CCCCCCCCCC)O1 ; CCCCCCCCCC1CCCC(=O)O1 ; CCCCCCCCC1(C)CCC(=O)O1 ; CCCCCCCCCC1(C)CCC(=O)O1 ; CCCCCCCCCCCC1CCC(=O)O1]

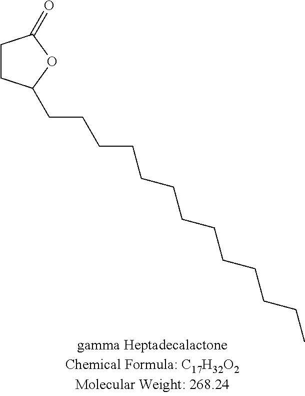 [SMILES: CCCCCCCCCCCCCC1CCC(=O)O1]

Especially preferred compounds of structure (A) of compounds (a) include methyl apritone, methyl dihydrojasmonate, propyl dihydrojasmonate, gamma-dodecalactone, delta-dodecalactone, gamma-tridecalactone, gamma-tetradecalactone, gamma methyl dodecalactone, gamma methyl tridecalactone, 3-methyl-5-pentyl-2-cyclohexenone, 3-methyl-5-pentyl-2-cyclohexenol, 3-methyl-5-hexyl-2-cyclohexenone, and 3-methyl-5-heptyl-2-cyclohexenone.

Representative examples of carboxylic acids of compounds (a) include, but are not limited to, lactic acid, salicylic acid, geranic acid, citronellic acid, 3-methyl-2-decenoic acid, and any isomers thereof. Preferred carboxylic acids of compounds (a) include the following having the formula:

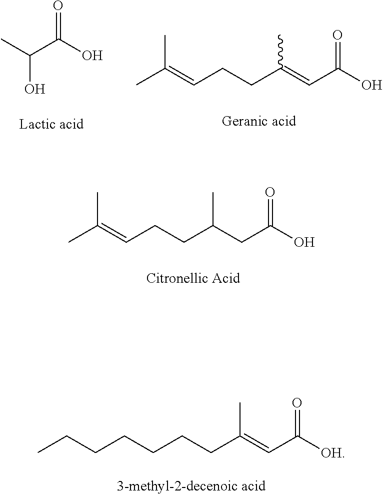

Representative examples of esters of carboxylic acids of compounds (a) include, but are not limited to, methyl lactate, ethyl lactate, propyl lactate, butyl lactate, amyl lactate, isoamyl lactate, hexyl lactate, cis-3-hexenyl lactate, methyl geranate, ethyl geranate, isoamyl geranate, methyl citronellate, ethyl citronellate, methyl salicylate, ethyl salicylate, amyl salicylate, isoamyl salicylate, hexyl salicylate, cis-3-hexenyl salicylate, and any isomers thereof.

The synergistic formulations of this disclosure may be employed against any biting arthropod desired to be repelled or controlled. Such biting arthropods and insects include mosquitoes, bed bugs, biting flies, ticks, ants, fleas, biting midges, and spiders.

The synergistic formulations of compound (a) may be any combination that exhibits a synergistic effect against any biting arthropod to be repelled or controlled. Illustrative synergistic formulations of compound (a) include, for example, any combinations of (1) alkyl ketones, any combinations of (2) compounds of the structure (A), any combinations of (3) carboxylic acids, any combinations of (4) esters of carboxylic acids, any combinations between any of the (1) alkyl ketones, (2) compounds of the structure (A), (3) carboxylic acids, and/or (4) esters of carboxylic acids, and/or any combinations between any of the (1) alkyl ketones, (2) compounds of the structure (A), (3) carboxylic acids, and/or (4) esters of carboxylic acids and repellents DEET®, PMD, Picaridin, or other nitrogen containing repellents selected from amines, amides and nitrogen containing heterocyclic compounds.

The active compounds of the synergistic formulations may be formulated into any suitable formulations such as for example, including but not limited to, solutions, oils, creams, lotions, shampoos, aerosols or the like. Traditional inert carriers such as, including but not limited to, alcohols, esters and petroleum distillates, could be used to produce formulations of the active compounds to be used as repellent formulations. Another series of carriers are the biodegradable oils, including but not limited to, the Olestra® family of oils, isopropyl myristate and squalane.

When the formulation will be used as an aerosol, it is preferable to add a propellant. Suitable propellants include, but are not limited to, propane, butane, isobutane, dimethyl ether, carbon dioxide, nitrous oxide, nitrogen, and combinations thereof.

The total amount of active biting arthropod repellent compound utilized in any biting arthropod control or repellent formulation will depend upon the type of formulation used and the particular biting arthropod against which the formulation is employed but will generally range from about 0.5% to about 20% by weight in a carrier.

The active control compounds of the synergistic formulations may be applied to surfaces of or impregnated in clothing or fabric. The active ingredients may be applied to fabrics such as, but not limited to, mosquito nets. The amount of active material can be about 0.025 g/ft² to about 3.6 gift².

The synergistic formulations of active repellent ingredients may also be applied to outdoor materials such as, but not limited to, lawns, trees, shrubbery, or flooring to prevent the biting arthropods from resting there.

The formulations described above can be prepared by any convenient means, e.g., by mixing the active compound or active compounds with one or more other carriers or vehicles such as, including but not limited to, those described herein before.

While the disclosure has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

### EXAMPLES

Dose response curves were generated for both standard repellents as well as compounds of this disclosure.

### Stage 1: Laboratory Screening

A modified K & D chamber or “Gupta Box” was used to screen 4 compounds plus an untreated control, simultaneously. Five replicates of 250 adult female mosquitoes each were placed in clear plastic cages (Gupta boxes) with access to five warmed, blood-filled, membrane-covered wells. The mosquitoes used were Aedes aegypti. Membranes were treated with repellent dilutions or diluent only. Five replicates were tested, rotating positions within the chamber. Each replicate used a fresh batch of mosquitoes, blood and treated membranes. The number of mosquitoes probing each well was recorded at two minute intervals for 20 minutes. The total numbers of probes on each well were tallied at the end of the observation period and the average percentage repellency relative to the control was calculated for each formulation.

To compare formulations from different tests, the control probes were adjusted to 100 for each test and the formula then applied to each formulation to adjust accordingly.

### Stage 2: “Arm in Cage” Testing

A Modified WHO—Nigel Hill protocol was used for Dose Response curve generation. Three concurrent repetitions were conducted with 4 subjects (2 male, 2 female). Approximately 60 non blood-fed, female Aedes aegypti mosquitoes were placed in a 12″X12″X12″ (28316.85 cm³) plexi and screen cage.

Subjects had an area of approximately 230 cm² marked off, between wrist and elbow, which was treated at a rate of ˜1.56 μL/cm². Arms were inserted into the first cage for 30 seconds, with number of landings (with intent to bite) recorded at the end of the time interval. The same procedure was used for the 2nd and 3rd cage in succession. Control arm was inserted first, followed by the opposite arm treated with ethanol only (as a treatment control). The ‘treatment arm’ is then treated with dose 1 and inserted, then dose 2, dose 3, and so on. After complete protection was achieved, control arm was reinserted to verify continued activity.

Percent repellency was calculated by utilizing the formula [{(C−T)/C}*100]. Where C=the number of mosquitoes landing with intent to bite on the ethanol only treated arm, and T=the number of mosquitoes landing with intent to bite on the ‘repellent’ treated arm. LDP Line® software (Bakr, E 2007) was used to determine ED50 (effective dose to repel 50%) and compare materials.

### Determination of Synergy:

Following the Definition of Synergy (the interaction or cooperation of two or more organizations, substances, or other agents to produce a combined effect greater than the sum of their separate effects), an ‘additive measure’ was used to determine synergy in the laboratory testing, as well as in the human testing. To determine significant differences between treatments, we used the Log Dose Probit method and generated LDP lines (for human dose response curves) to determine the ED50 (the effective dose required to achieve 50% repellency) of individual compounds and then we combined the compounds to determine if significantly less amount of material was needed to create the same effect. Significance was determined by the use of 95% confidence intervals. If confidence intervals did not overlap, there was a significant difference in treatments.

For laboratory testing, additive repellency was determined by adding the adjusted percent repellency for each dose used in the combination treatment. This “Expected additive repellency” was then compared to the “actual repellency” seen when the combination was tested in the Gupta box.

For human testing, the LDP Line software was used to determine “additive repellency” differences. After generating the dose response curves, we combined the percent dose required to generate an ED25 (25% repellency) for each of the individual components and entered that % dose (i.e., 0.035% DEET+0.128% PMD=0.163%) into the dose response curve (using the LDP Line program) for the combination to determine if the addition of the two materials would be less than, greater than or equal to theoretical additive repellency number of 50%.

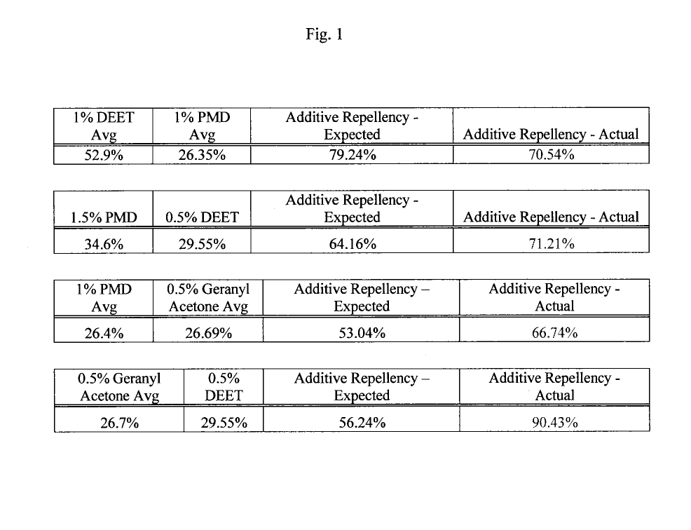

FIG. 1 shows the results of laboratory testing for additive repellency of certain combinations of compounds in accordance with this disclosure.

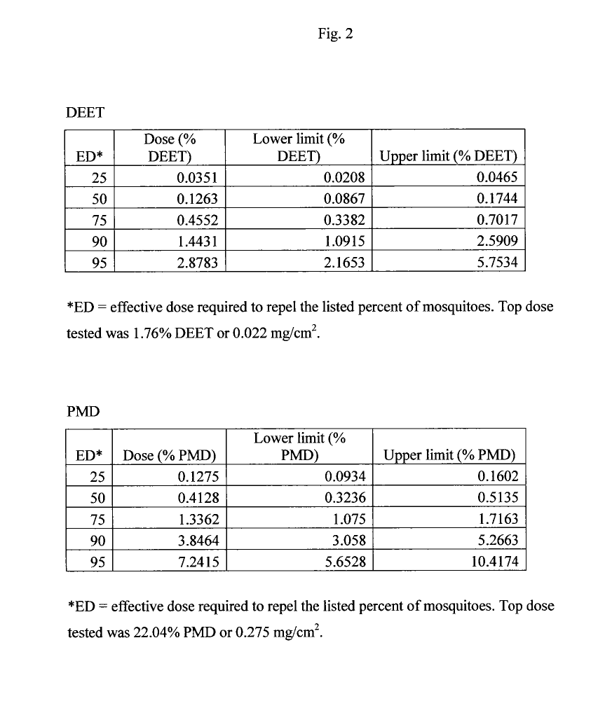

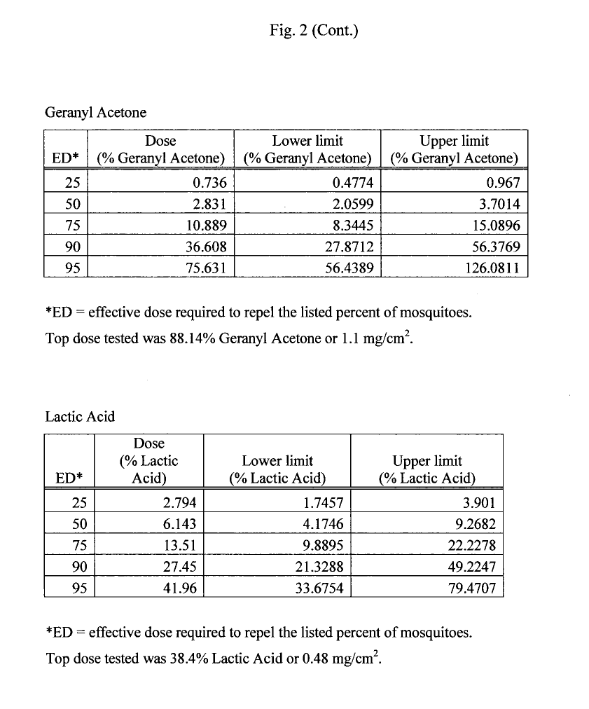

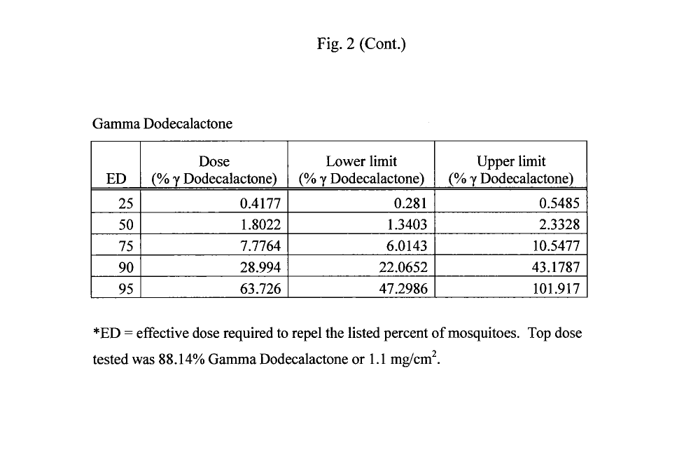

FIG. 2 shows the results of human testing for dose response curves of certain individual compounds in accordance with this disclosure.

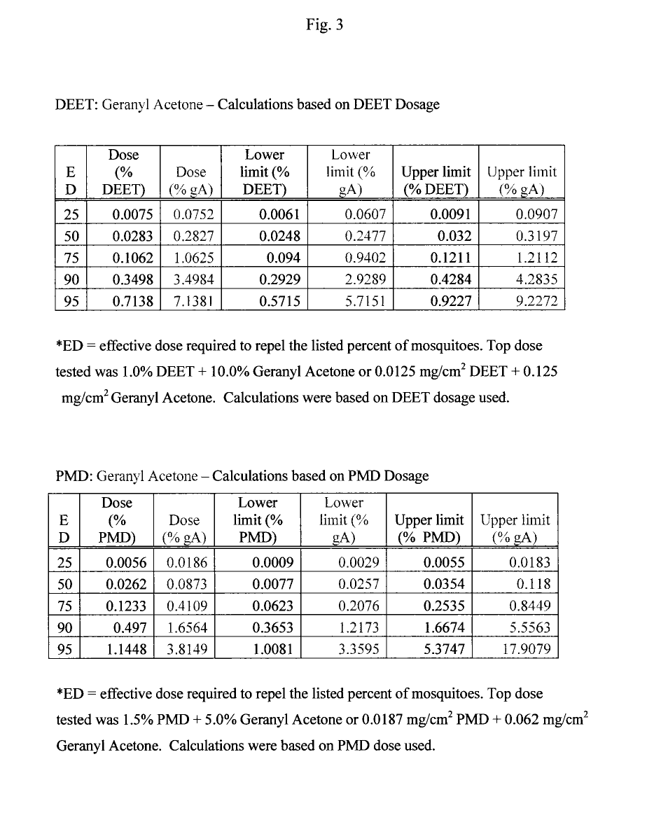

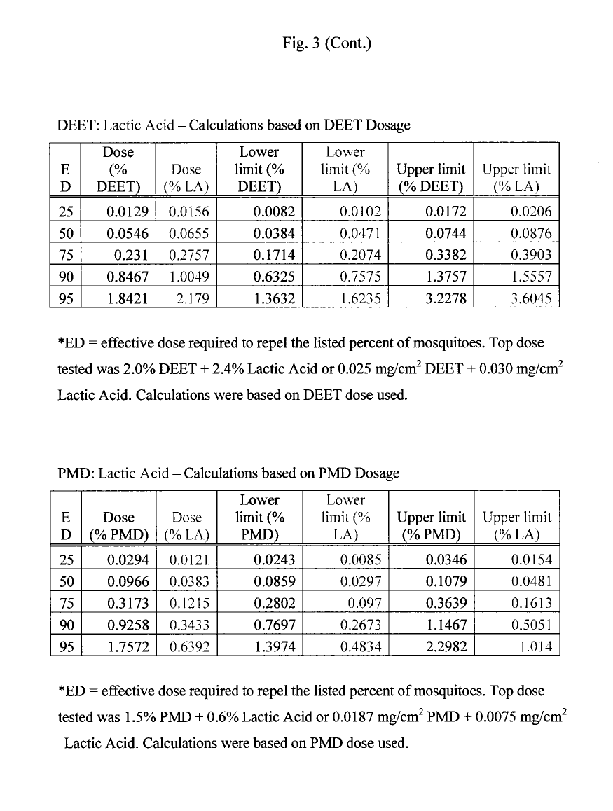

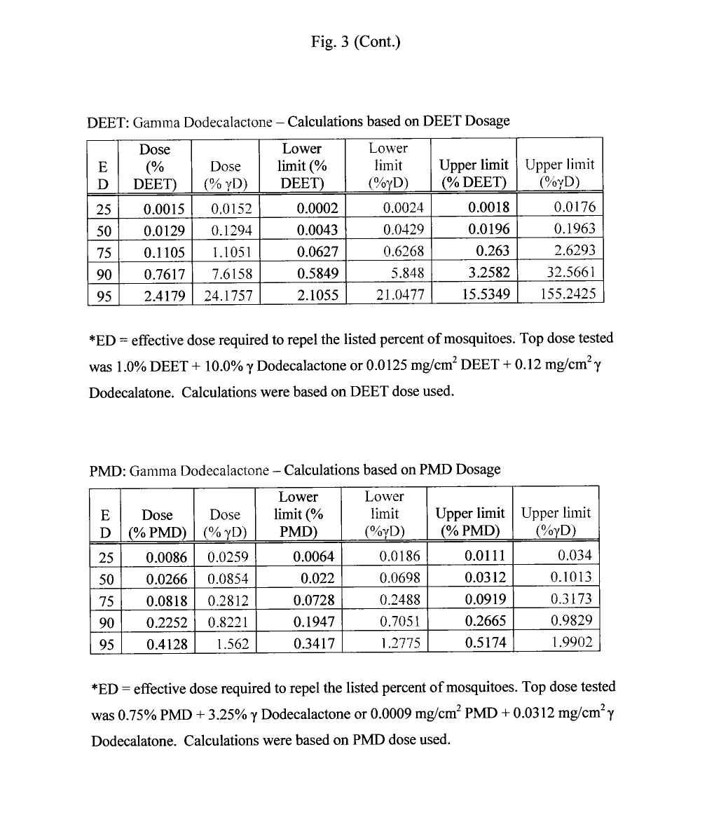

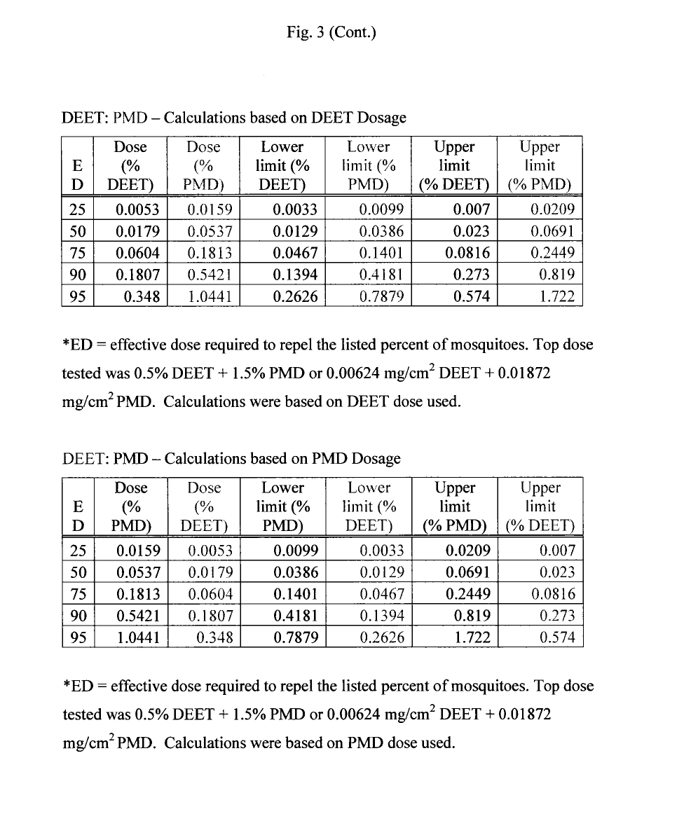

FIG. 3 shows the results of human testing for dose response curves of certain combinations of compounds in accordance with this disclosure.

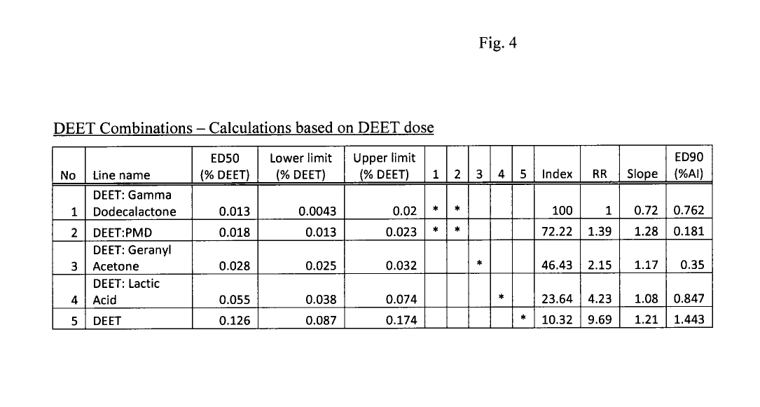

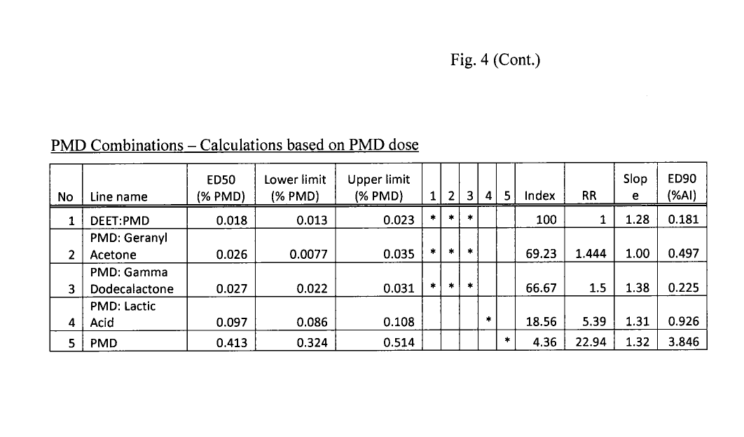

FIG. 4 shows the results of ED50 comparisons of certain combinations of compounds, based on the dose of DEET or PMD, in accordance with this disclosure. For both DEET and PMD, when compounds of this disclosure were added to the conventional repellent, the ED50 was significantly decreased; indicating that greater repellency was achieved with significantly less of the conventional repellent. This was also true for the combination of the two conventional repellents, DEET+PMD.

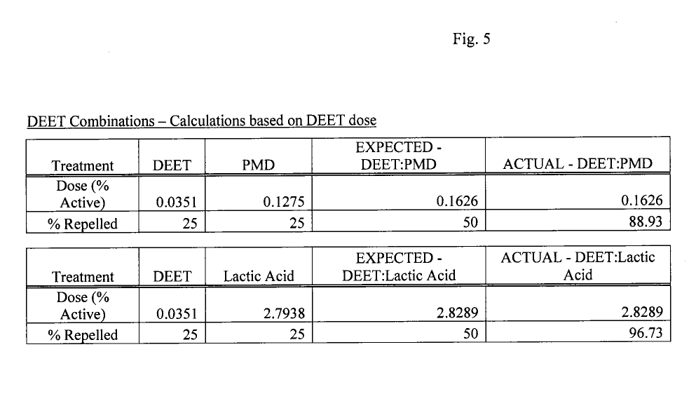

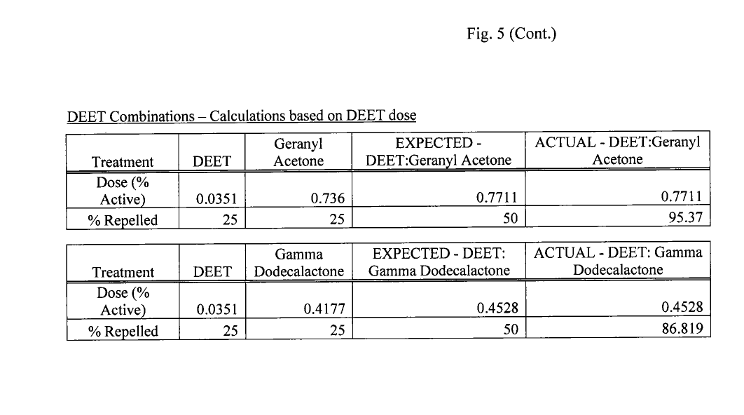

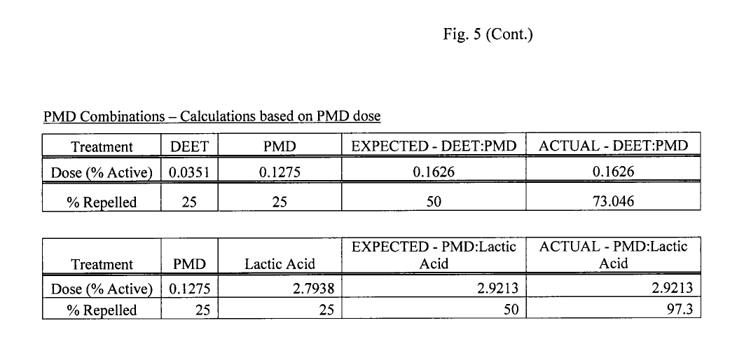

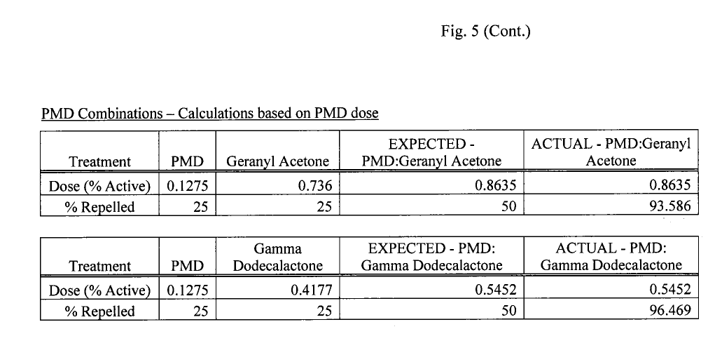

FIG. 5 shows the results of additive comparisons of certain combinations of compounds, based on the dose of DEET or PMD, in accordance with this disclosure. LDP Line software was used to determine “additive repellency” differences. After generating the dose response curves, the percent dose required to generate an ED25 (25% repellency) for each of the individual components was combined and that % dose (i.e. 0.035% DEET+0.128% PMD=0.163%) entered into the dose response curve (using the LDP Line program) for the combination to determine if the addition of the two materials would be less than, greater than or equal to the theoretical additive repellency number of 50%. For both DEET and PMD, when compounds of this disclosure were added to the conventional repellent, the additive effect was greater than the theoretical 50% ‘expected’ by the addition of the doses that generated 25% repellency. This was also true for the combination of the two conventional repellents, DEET+PMD.

I claim:

1. A method for the control or repellency of biting arthropods, the method comprising bringing the biting arthropods into contact with a synergistic biting arthropod repellent formulation wherein the synergistic biting arthropod formulation comprises a synergistic formulation selected from:
(I) any synergistic combination of compounds (a), wherein compounds (a) are selected from the group comprising or consisting of:
(1) alkyl ketones, saturated or unsaturated, branched or unbranched, containing from about 6 to about 18 carbon atoms, or any range of carbon atoms within said range;
(2) compounds of the structure (A) 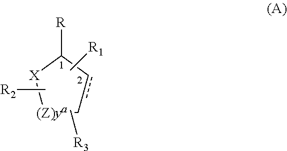
wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R, can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)—OH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond; and
wherein the compounds of structure (A) contain from about 11 to about 20 carbon atoms except where R is ═O, X═CH₂ and y is 1 the compounds of structure (A) contain from about 13 to about 20 carbon atoms, and includes optical isomers, diastereomers and enantiomers of the compounds of structure (A); and
(3) branched or unbranched, straight chain or cyclic, saturated or unsaturated, carboxylic acids containing from about 3 to about 18 carbon atoms or any range of carbon atoms within said range, including isomers thereof; and
(4) esters of branched or unbranched, straight chain or cyclic, saturated or unsaturated, carboxylic acids containing from about 3 to about 18 carbon atoms or any range of carbon atoms within said range, including isomers thereof;
(II) one or more of the compounds (a) in combination with one or more of the repellents DEET®, para-Menthane-3,8-diol (PMD), Picaridin, or other nitrogen containing repellents selected from amines, amides and nitrogen containing heterocyclic compounds, and
(III) any synergistic combination of the repellents DEET®, PMD, Picaridin, or other nitrogen containing repellents selected from amines, amides and nitrogen containing heterocyclic compounds.

2. The method of claim 1 wherein the alkyl ketones of compound (a) comprise geranyl acetone (6,10-dimethyl-5,9-undecadien-2-one), farnesyl acetone (5,9,13-pentadecatrien-2-one), 6,10,14-trimethyl-) methyl undecyl ketone (2-tridecanone), methyl decyl ketone (2-dodecanone), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), isobutylionone ((E)-5-methyl-1-(2,6,6-trimethyl-1-cyclohex-2-enyl)hex-1-en-3-one), isolongifolen-9-one ((1R)-2,2,7,7-tetramethyltricyclo[6.2.1.01,6]undec-5-en-4-one), dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone (2-undecanone), and 3-decen-2-one.

3. The method of claim 1 wherein the alkyl ketones of compound (a) comprise methyl decyl ketone, methyl undecyl ketone, methyl nonyl ketone, geranyl acetone, farnesyl acetone, ionone, and isolongifolenone.

4. The method of claim 1 wherein the compounds of structure (A) of compound (a) comprise compounds having the formula

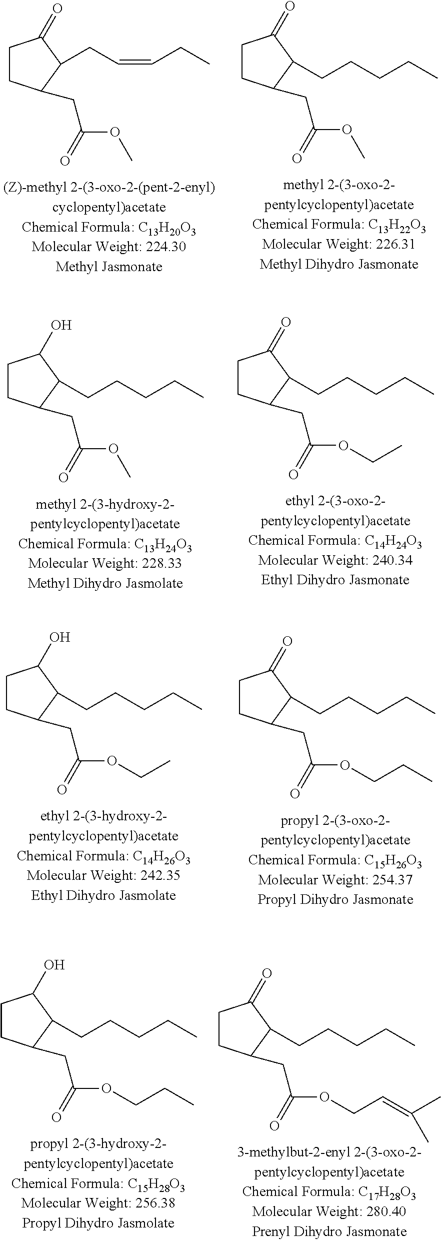

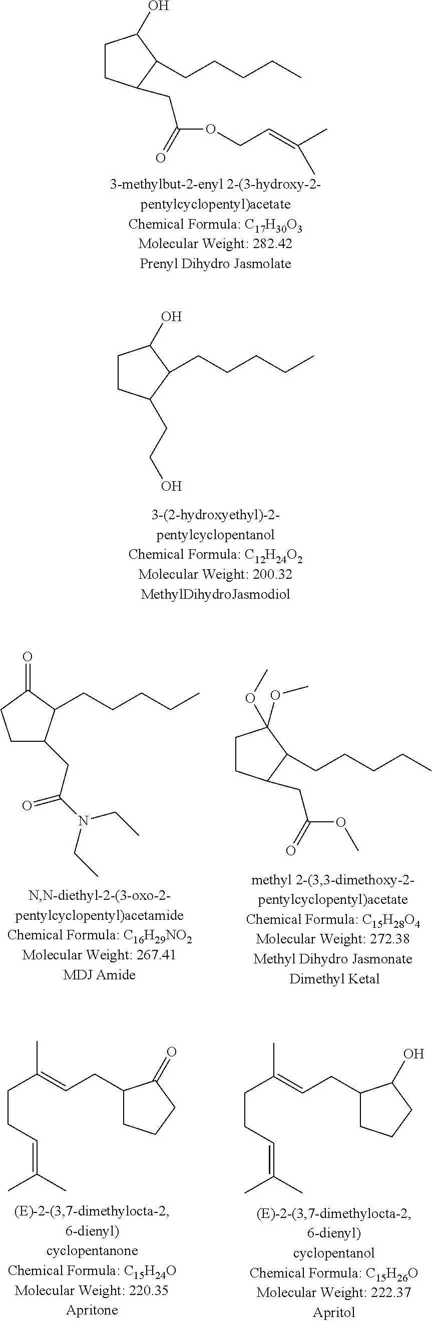 [SMILES: CCCCCC1C(O)CCC1CC(=O)OCC=C(C)C ; CCCCCC1C(O)CCC1CCO ; CCCCCC1C(=O)CCC1CC(=O)N(CC)CC ; CCCCCC1C(CC(=O)OC)CCC1(OC)OC ; CC(C)=CCC/C(C)=C/CC1CCCC1=O ; CC(C)=CCC/C(C)=C/CC1CCCC1O]

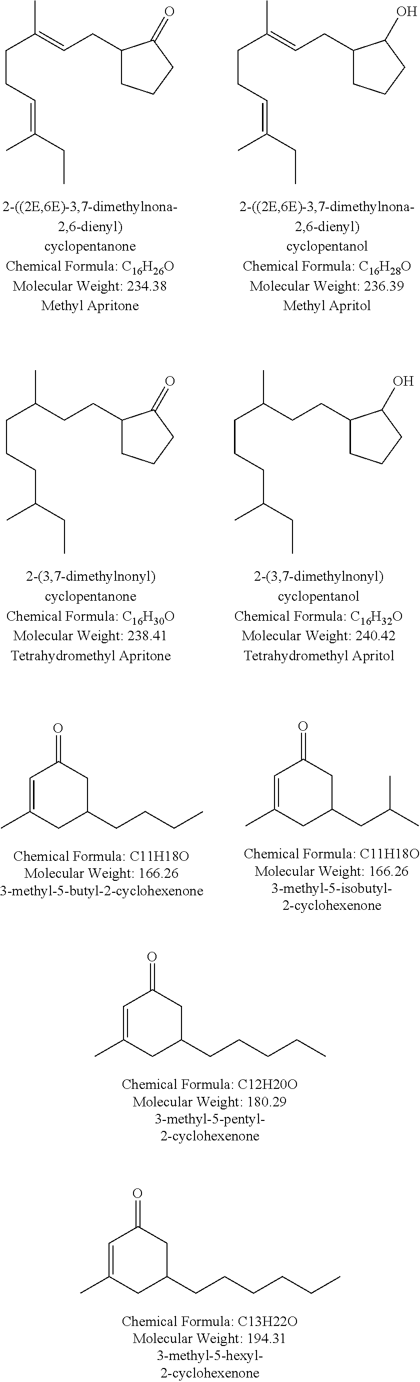

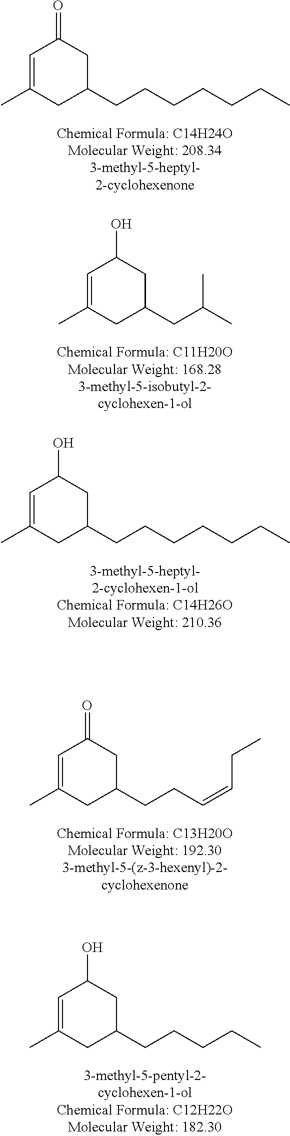

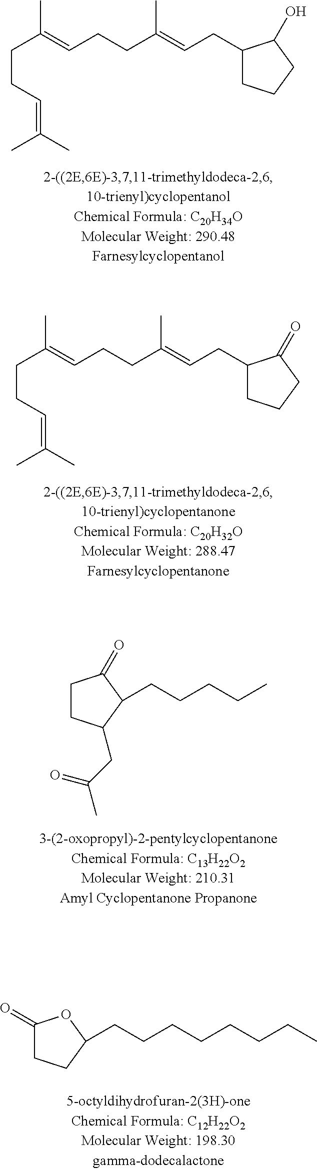 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O ; CCCCCCCCC1CCC(=O)O1]

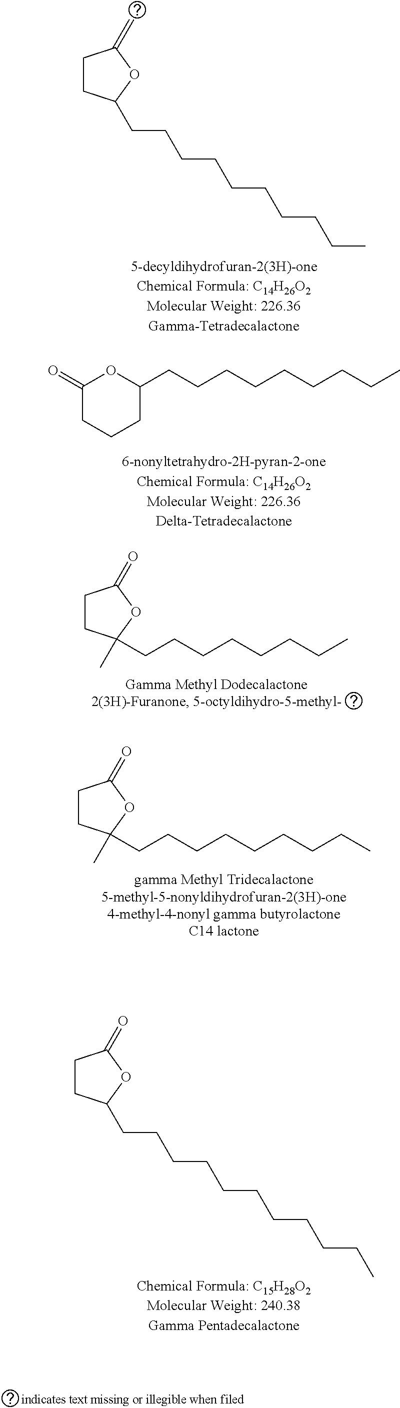 [SMILES: C=C1CCC(CCCCCCCCCC)O1 ; CCCCCCCCCC1CCCC(=O)O1 ; CCCCCCCCC1(C)CCC(=O)O1 ; CCCCCCCCCC1(C)CCC(=O)O1 ; CCCCCCCCCCCC1CCC(=O)O1]

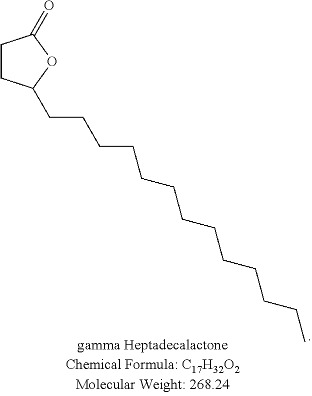 [SMILES: CCCCCCCCCCCCCC1CCC(=O)O1]

5. The method of claim 1 wherein the compounds of structure (A) of compounds (a) comprise methyl apritone, methyl dihydrojasmonate, propyl dihydrojasmonate, gamma-dodecalactone, delta-dodecalactone, gamma-tridecalactone, gamma-tetradecalactone, gamma methyl dodecalactone, gamma methyl tridecalactone, 3-methyl-5-pentyl-2-cyclohexenone, 3-methyl-5-pentyl-2-cyclohexenol, 3-methyl-5-hexyl-2-cyclohexenone, and 3-methyl-5-heptyl-2-cyclohexenone.

6. The method of claim 1 wherein the carboxylic acids of compounds (a) comprise lactic acid, salicylic acid, geranic acid, citronellic acid, 3-methyl-2-decenoic acid, and any isomers thereof.

7. The method of claim 1 wherein the carboxylic acids of compounds (a) comprise lactic acid and isomers thereof.

8. The method of claim 1 wherein the esters of carboxylic acids of compounds (a) comprise methyl lactate, ethyl lactate, propyl lactate, butyl lactate, amyl lactate, isoamyl lactate, hexyl lactate, cis-3-hexenyl lactate, methyl geranate, ethyl geranate, isoamyl geranate, methyl citronellate, ethyl citronellate, methyl salicylate, ethyl salicylate, amyl salicylate, isoamyl salicylate, hexyl salicylate, cis-3-hexenyl salicylate, and any isomers thereof.

9. The method of claim 1 wherein the esters of carboxylic acids of compounds (a) comprise esters of salicylic acid and any isomers thereof.

10. The method of claim 1 wherein the synergistic formulation comprises: lactic acid in combination with one or more alkyl ketones; lactic acid in combination with one or more compounds of structure (A); lactic acid in combination with one or more other carboxylic acids; lactic acid in combination with one or more esters of carboxylic acids; or lactic acid in combination one or more of the repellents DEET®, PMD, Picaridin, or other nitrogen containing repellents selected from amines, amides and nitrogen containing heterocyclic compounds.

11. The method of claim 1 wherein the synergistic formulation comprises: geranyl acetone in combination with one or more other alkyl ketones; geranyl acetone in combination with one or more compounds of structure (A); geranyl acetone in combination with one or more carboxylic acids; geranyl acetone in combination with one or more esters of carboxylic acids; or geranyl acetone in combination one or more of the repellents DEBT®, PMD, Picaridin, or other nitrogen containing repellents selected from amines, amides and nitrogen containing heterocyclic compounds.

12. The method of claim 1 wherein the synergistic formulation comprises: gamma or delta dodecalactone in combination with one or more alkyl ketones; gamma or delta dodecalactone in combination with one or more compounds of structure (A); gamma or delta dodecalactone in combination with one or more carboxylic acids; gamma or delta dodecalactone in combination with one or more esters of carboxylic acids; or gamma or delta dodecalactone in combination one or more of the repellents DEET®, PMD, Picaridin, or other nitrogen containing repellents selected from amines, amides and nitrogen containing heterocyclic compounds.

13. The method of claim 1 wherein the synergistic formulation comprises: two or more repellents DEBT®, PMD, Picaridin, or other nitrogen containing repellents selected from amines, amides and nitrogen containing heterocyclic compounds.

14. A synergistic biting arthropod repellent formulation wherein the synergistic biting arthropod formulation comprises a synergistic formulation selected from:
(I) any synergistic combination of compounds (a), wherein compounds (a) are selected from the group comprising or consisting of:
(1) alkyl ketones, saturated or unsaturated, branched or unbranched, containing from about 6 to about 18 carbon atoms, or any range of carbon atoms within said range;
(2) compounds of the structure (A) 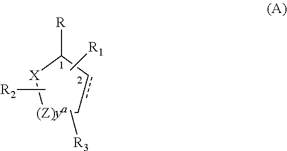
wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is O or CH₂, with the proviso that when X is O, R, can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)₆OH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond; and
wherein the compounds of structure (A) contain from about 11 to about 20 carbon atoms except where R is ═O, X═CH₂ and y is 1 the compounds of structure (A) contain from about 13 to about 20 carbon atoms, and includes optical isomers, diastereomers and enantiomers of the compounds of structure (A); and
(3) branched or unbranched, straight chain or cyclic, saturated or unsaturated, carboxylic acids containing from about 3 to about 18 carbon atoms or any range of carbon atoms within said range, including isomers thereof; and
(4) esters of branched or unbranched, straight chain or cyclic, saturated or unsaturated, carboxylic acids containing from about 3 to about 18 carbon atoms or any range of carbon atoms within said range, including isomers thereof;
(II) one or more of the compounds (a) in combination with one or more of the repellents DEET®, para-Menthane-3,8-diol (PMD), Picaridin, or other nitrogen containing repellents selected from amines, amides and nitrogen containing heterocyclic compounds, and
(III) any synergistic combination of the repellents DEET®, PMD, Picaridin, or other nitrogen containing repellents selected from amines, amides and nitrogen containing heterocyclic compounds.

15. The formulation of claim 14 wherein the alkyl ketones of compound (a) comprise geranyl acetone (6,10-dimethyl-5,9-undecadien-2-one), farnesyl acetone (5,9,13-pentadecatrien-2-one), 6,10,14-trimethyl-) methyl undecyl ketone (2-tridecanone), methyl decyl ketone (2-dodecanone), alpha-ionone (4-(2,6,6-trimethyl-2-cyclohexenyl)-3-buten-2-one), beta ionone (4-(2,6,6-trimethyl-1-cyclohexenyl)-3-buten-2-one), alpha-isomethylionone (3-methyl-4-(2,6,6-trimethyl-2-cyclohexen-1-yl)-3-buten-2-one), isobutylionone ((E)-5-methyl-1-(2,6,6-trimethyl-1-cyclohex-2-enyl)hex-1-en-3-one), isolongifolen-9-one ((1R)-2,2,7,7-tetramethyltricyclo[6.2.1.01,6]undec-5-en-4-one), dimethylionone ((E)-2-methyl-1-(2,2,6-trimethyl-1-cyclohex-3-enyl)pent-1-en-3-one), isolongifolanone (2,2,7,7-tetramethyltricyclo[6.2.1.01,6]undecan-5-one), pseudoionone (6,10-dimethyl-3,5,9-undecatrien-2-one), 2-cyclopentylcyclopentanone, methyl nonyl ketone (2-undecanone), and 3-decen-2-one.

16. The formulation of claim 14 wherein the alkyl ketones of compound (a) comprise methyl decyl ketone, methyl undecyl ketone, methyl nonyl ketone, geranyl acetone, farnesyl acetone, ionone, and isolongifolenone.

17. The formulation of claim 14 wherein the compounds of structure (A) of compound (a) comprise compounds having the formula

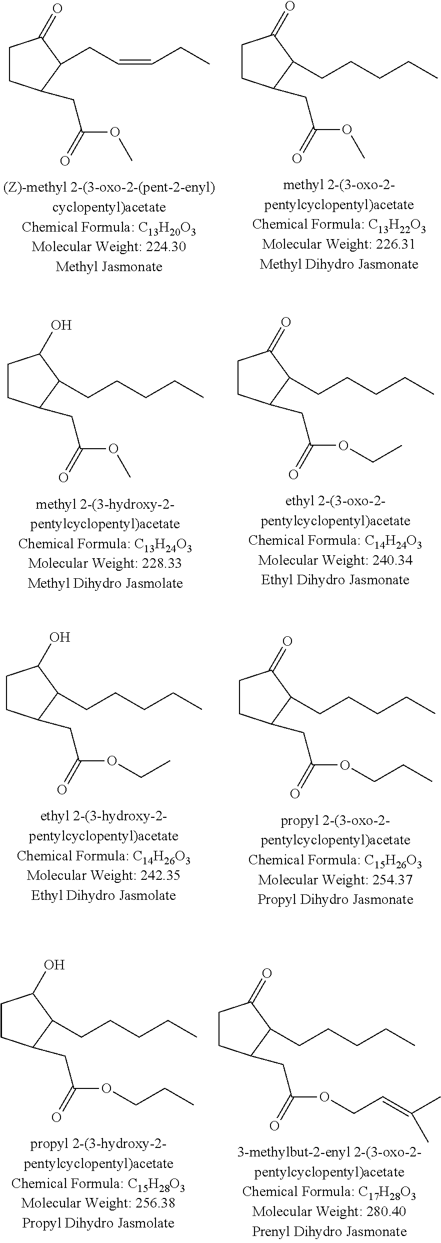

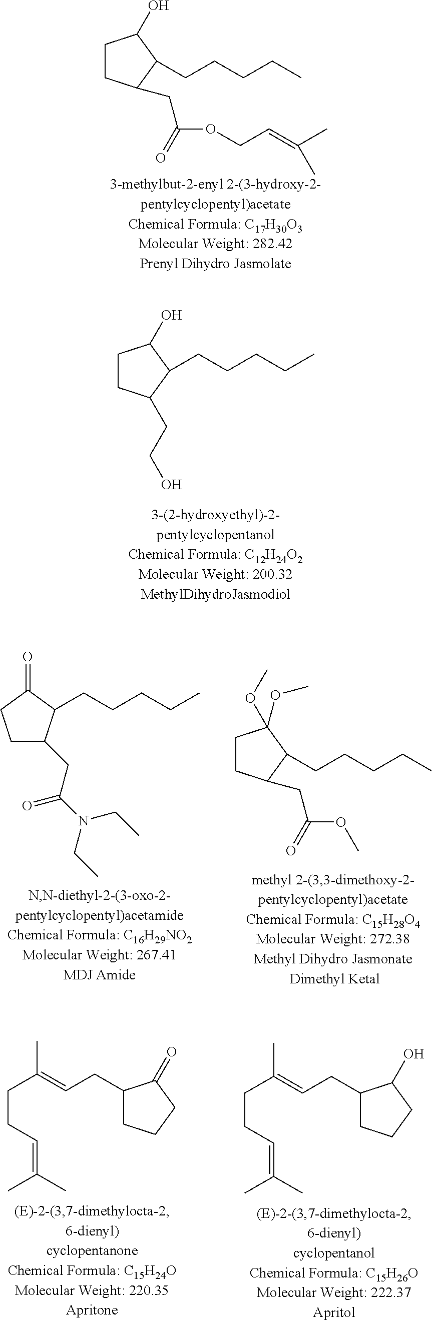 [SMILES: CCCCCC1C(O)CCC1CC(=O)OCC=C(C)C ; CCCCCC1C(O)CCC1CCO ; CCCCCC1C(=O)CCC1CC(=O)N(CC)CC ; CCCCCC1C(CC(=O)OC)CCC1(OC)OC ; CC(C)=CCC/C(C)=C/CC1CCCC1=O ; CC(C)=CCC/C(C)=C/CC1CCCC1O]

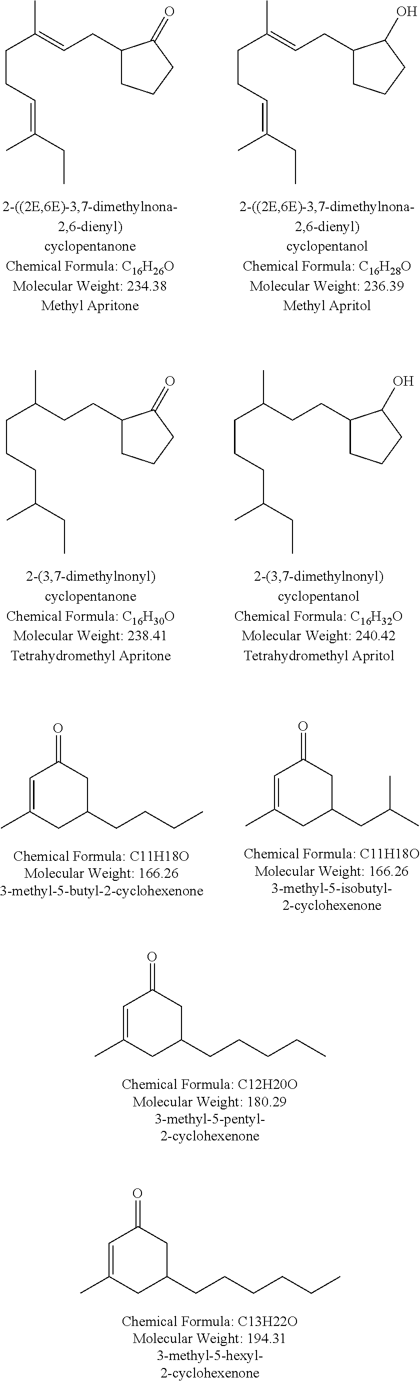

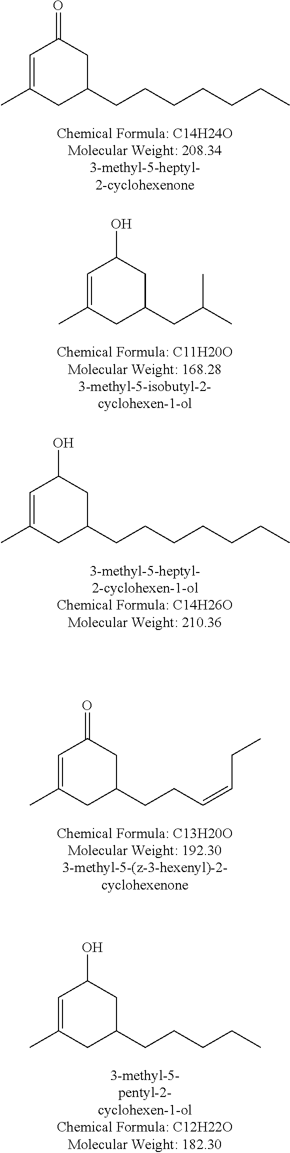

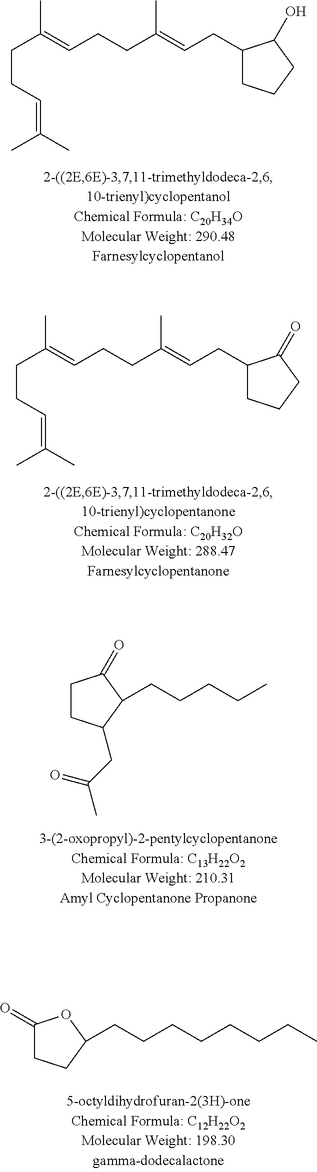 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O ; CCCCCCCCC1CCC(=O)O1]

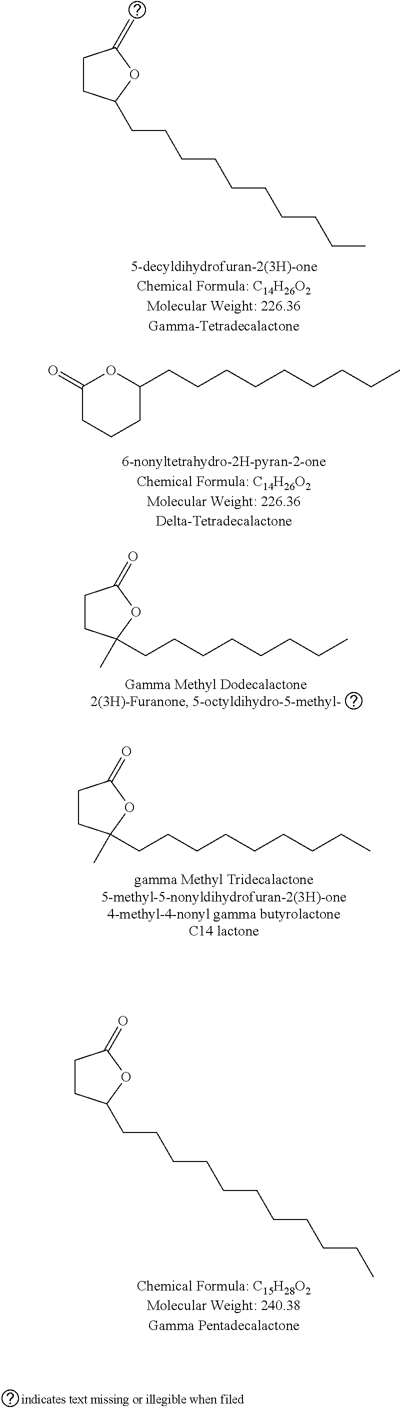 [SMILES: C=C1CCC(CCCCCCCCCC)O1 ; CCCCCCCCCC1CCCC(=O)O1 ; CCCCCCCCC1(C)CCC(=O)O1 ; CCCCCCCCCC1(C)CCC(=O)O1 ; CCCCCCCCCCCC1CCC(=O)O1]

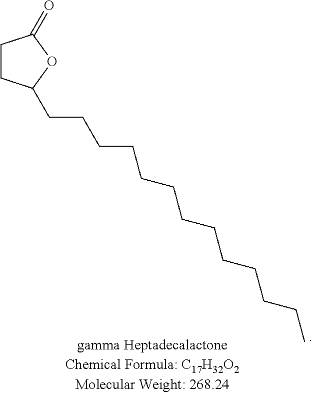 [SMILES: CCCCCCCCCCCCCC1CCC(=O)O1]

18. The formulation of claim 14 wherein the compounds of structure (A) of compounds (a) comprise methyl apritone, methyl dihydrojasmonate, propyl dihydrojasmonate, gamma-dodecalactone, delta-dodecalactone, gamma-tridecalactone, gamma-tetradecalactone, gamma methyl dodecalactone, gamma methyl tridecalactone, 3-methyl-5-pentyl-2-cyclohexenone, 3-methyl-5-pentyl-2-cyclohexenol, 3-methyl-5-hexyl-2-cyclohexenone, and 3-methyl-5-heptyl-2-cyclohexenone.

19. The formulation of claim 14 wherein the carboxylic acids of compounds (a) comprise lactic acid, salicylic acid, geranic acid, citronellic acid, 3-methyl-2-decenoic acid, and any isomers thereof.

20. The formulation of claim 14 wherein the carboxylic acids of compounds (a) comprise lactic acid and isomers thereof.

21. The formulation of claim 14 wherein the esters of carboxylic acids of compounds (a) comprise methyl lactate, ethyl lactate, propyl lactate, butyl lactate, amyl lactate, isoamyl lactate, hexyl lactate, cis-3-hexenyl lactate, methyl geranate, ethyl geranate, isoamyl geranate, methyl citronellate, ethyl citronellate, methyl salicylate, ethyl salicylate, amyl salicylate, isoamyl salicylate, hexyl salicylate, cis-3-hexenyl salicylate, and any isomers thereof.

22. The formulation of claim 14 wherein the esters of carboxylic acids of compounds (a) comprise esters of salicylic acid and any isomers thereof.

23. The formulation of claim 14 wherein the synergistic formulation comprises: lactic acid in combination with one or more alkyl ketones; lactic acid in combination with one or more compounds of structure (A); lactic acid in combination with one or more other carboxylic acids; lactic acid in combination with one or more esters of carboxylic acids; or lactic acid in combination one or more of the repellents DEET®, PMD, Picaridin, or other nitrogen containing repellents selected from amines, amides and nitrogen containing heterocyclic compounds.

24. The formulation of claim 14 wherein the synergistic formulation comprises: geranyl acetone in combination with one or more other alkyl ketones; geranyl acetone in combination with one or more compounds of structure (A); geranyl acetone in combination with one or more carboxylic acids; geranyl acetone in combination with one or more esters of carboxylic acids; or geranyl acetone in combination one or more of the repellents DEET®, PMD, Picaridin, or other nitrogen containing repellents selected from amines, amides and nitrogen containing heterocyclic compounds.

25. The formulation of claim 14 wherein the synergistic formulation comprises: gamma or delta dodecalactone in combination with one or more alkyl ketones; gamma or delta dodecalactone in combination with one or more compounds of structure (A); gamma or delta dodecalactone in combination with one or more carboxylic acids; gamma or delta dodecalactone in combination with one or more esters of carboxylic acids; or gamma or delta dodecalactone in combination one or more of the repellents DEET®, PMD, Picaridin, or other nitrogen containing repellents selected from amines, amides and nitrogen containing heterocyclic compounds.

26. The formulation of claim 14 wherein the synergistic formulation comprises: two or more repellents DEET®, PMD, Picaridin, or other nitrogen containing repellents selected from amines, amides and nitrogen containing heterocyclic compounds.
